(19) United States
(12) Patent Application Publication
(10) Pub. No.: US 2026/0134273 A1
(43) Pub. Date: May 14, 2026

(54) Spatially Varying Nanophotonic Neural Networks

(71) Applicants: The Trustees of Princeton University, Princeton, NJ (US); University of Washington, Seattle, WA (US)

(72) Inventors: Praneeth CHAKRAVARTHULA, Princeton, NJ (US); Johannes Emanuel FROCH, Seattle, WA (US); Felix HEIDE, Princeton, NJ (US); Xiao LI, Princeton, NJ (US); Arka MAJUMDAR, Seattle, WA (US); Ethan TSENG, Princeton, NJ (US); James WHITEHEAD, Seattle, WA (US)

(21) Appl. No.: 18/936,075

(22) Filed: Nov. 4, 2024

Related U.S. Application Data
(60) Provisional application No. 63/547,007, filed on Nov. 2, 2023.

(51) Int. Cl. G06N 3/067; G06N 3/0464

(52) U.S. Cl. CPC G06N 3/0675; G06N 3/0464

(57) ABSTRACT

A nanophotonic neural network, wherein the nanophotonic neural network comprises a large-kernel spatially-varying convolutional neural network. The large-kernel spatially-varying convolutional neural network is learned via a low-dimensional re-parameterization technique. The large-kernel spatially-varying convolutional neural network comprises a flat meta-optical system that encompasses an array of nanophotonic structures designed to induce angle-dependent responses. The large-kernel spatially-varying convolutional neural network comprises an extremely lightweight electronic backend with approximately 2K parameters configured to reach a 73.80% blind test classification accuracy on CIFAR-10 dataset.

### CROSS-REFERENCE TO RELATED APPLICATIONS

This application claims benefit of priority of U.S. Patent Application No. 63/547,007 filed Nov. 2, 2023, entitled, “SPATIALLY VARYING NANOPHOTONIC NEURAL NETWORKS”. The entire contents and disclosures of this patent application is incorporated herein by reference in their entirety.

### GOVERNMENT INTEREST STATEMENT

This invention was made with government support under Grant No. U.S. Pat. No. 2,047,359 awarded by the National Science Foundation and W31P4Q-21-C-0043 awarded by the Defense Advanced Research Projects Agency (DARPA). The government has certain rights in the invention.

### BACKGROUND

### Field of the Invention

The present disclosure relates generally to nanophotonic neural networks and optical neural network techniques.

### Background of the Invention

The explosive growth of computation and energy cost of artificial intelligence has spurred strong interests in new computing modalities as potential alternatives to conventional electronic processors. Photonic processors that execute operations using photons instead of electrons, have promised to enable optical neural networks with ultra-low latency and power consumption. However, existing optical neural networks, limited by the underlying net-work designs, have achieved image recognition accuracy much lower than state-of-the-art electronic neural networks. Thus, there is a need to close this gap by developing improved neural network designs and optical imaging techniques.

### SUMMARY

According to first broad aspect, the present disclosure provides a nanophotonic neural network, wherein the nanophotonic neural network comprises a large-kernel spatially-varying convolutional neural network, wherein the large-kernel spatially-varying convolutional neural network is learned via a low-dimensional re-parameterization technique, wherein the large-kernel spatially-varying convolutional neural network comprises a flat meta-optical system that encompasses an array of nanophotonic structures designed to induce angle-dependent responses. In some disclosed embodiments, the large-kernel spatially-varying convolutional neural network comprises an electronic backend with approximately 2K parameters configured to reach a 73.80% blind test classification accuracy on CIFAR-10 dataset.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The accompanying drawings, which are incorporated herein and constitute part of this specification, illustrate exemplary embodiments of the invention, and, together with the general description given above and the detailed description given below, serve to explain the features of the invention.

FIG. 1 illustrates spatially varying nanophotonic neural networks according to one embodiment of the present disclosure.

FIG. 2 illustrates an experimental validation of SVN³ according to one embodiment of the present disclosure.

FIG. 3 illustrates experimental measurements of a fabricated chip of a design for CIFAR-10 image classification according to one embodiment of the present disclosure.

FIG. 4 illustrates experimental classification results on random samples from a CIFAR-10 test set according to one embodiment of the present disclosure.

FIG. 5 illustrates validation of SVN³ as a versatile computational camera according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as disclosed embodiments as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

### DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

### INTRODUCTION

Increasing demands for high-performance artificial intelligence in the last decade have levied immense pressure on computing architectures across domains, including robotics, transportation, personal devices, medical imaging and scientific imaging. Although electronic microprocessors have undergone drastic evolution over the past 50 years¹, providing us with general-purpose CPUs and custom accelerator platforms (e.g., GPU, DSP ASICs), this growth rate is far outpaced by the explosive growth of AI models. Specifically, Moore's law delivers a doubling in transistor counts every two years² whereas deep neural networks (DNN)³, arguably the most influential algorithms in AI, have doubled in size every six months⁴. However, in fact, the end of voltage scaling has made the power consumption, and not the number of transistors, the principal factor limiting further improvements in computing performance⁵. Overcoming this limitation and radically reducing compute latency and power consumption could drive unprecedented applications from low-power edge computation in the camera, potentially enabling computation in thin eye-glasses or micro-robots, and reducing power consumption in data centers used for training of neural network architectures.

In this work, disclosed embodiments close this gap by introducing a large-kernel spatially-varying convolutional neural network learned via low-dimensional re-parameterization techniques. Disclosed embodiments experimentally instantiate the network with a flat meta-optical system that encompasses an array of nanophotonic structures designed to induce angle-dependent responses. Combined with an extremely lightweight electronic backend with approximately 2K parameters disclosed embodiments demonstrate a nanophotonic neural network reaches 73.80% blind test classification accuracy on CIFAR-10 dataset, and, as such, the first time, an optical neural network outperforms the first modern digital neural network—AlexNet (72.64%) with 57M parameters as more fully discussed below.

Optical computing has been proposed as an approach to alleviate several inherent limitations of digital electronics, e.g., compute speed, heat dissipation, and power, and could potentially boost computational throughput, processing speed, and energy efficiency by orders of magnitude⁶⁻⁸. Although general-purpose optical computing has yet to be practically realized due to obstacles such as larger physical footprints and inefficient optical switches^{9, 10}, several signific-ant advances have already been made towards optical/photonic processors tailored specifically for AI¹¹⁻¹³. Representative examples include optical computers that perform widely-used signal processing operators¹⁴⁻¹⁸, (e.g., spatial/temporal differentiation, integration, and convolution) and mathematical solvers19, 20 with performance far beyond those of contemporary electronic processors. Most strikingly, optical neural networks (ONN)²¹⁻³⁷ can perform AI inference tasks such as image recognition when implemented as fully-optical or hybrid opto-electronical computers.

Existing ONNs can be broadly classified into two categories based upon either integrated photonics²¹⁻²⁷ (e.g., Mach-Zehnder interferometers²³, phase change materials²¹ microring resonators²⁶, multimode fibers²⁷) for physically realizing multiply-accumulate (MAC) operations, or with free-space optics²⁸⁻³⁸ that implement convolutional layers with light propagation through diffractive elements (e.g., 3D-printed surfaces²⁸, 4F optical correlators³⁷, optical masks³⁵, metasurfaces³⁶). The design of these ONN architectures has been fundamentally restricted by the underlying net-work design, including the challenge of scaling to large numbers of neurons (within integrated photonic circuits) and the lack of scalable energy-efficient nonlinear optical operators. As a result, even the most successful ensemble ONNs³¹ that employ dozens of ONNs in parallel, have only achieved LeNet³⁹-level accuracy on image classification, which was achieved by their electronic counterparts over 30 years ago. Moreover, most high-performance ONNs can only operate under coherent illumination, prohibiting the integration into the camera optics under natural lighting conditions. Although hybrid optoelectronic networks^{35, 36} working on incoherent light do exist, they yield inferior results as their optical frontend is designed to execute only a single convolutional layer.

In contrast, disclosed embodiments report a novel nanophotonic neural network that lifts the aforementioned limitations, allowing us to close the gap to the first modern DNN architectures⁴⁰ with optical compute in a flat form factor of only 2 mm length. Disclosed embodiments leverage the ability of a lens system to perform large-kernel spatially-varying convolutions tailored specifically for image recognition and semantic segmentation. In order to design these kernels, disclosed embodiments learn these large kernels via low-dimensional re-parameterization techniques which circumvent spurious local extremum caused by direct optimization. To physically realize the ONN, disclosed embodiments develop a differentiable spatially varying inverse design framework that solves for metasurfaces^{41, 42} that can produce the desired angle-dependent responses under spatially incoherent illumination. Because of the compact footprint and CMOS sensor compatibility, the resulting optical system is not only a photonic accelerator, but also an ultra-compact computational camera that directly structures lights in ambient environments. By on-chip integration of this flat-optics frontend (>99% MACs) with an extremely lightweight electronic backend (<1% MACs), disclosed embodiments achieve higher classification performance than modern fully-electronic classifiers (73.80% on CIFAR-1043 compared to 72.64% by AlexNet40) while simultaneously reducing the number of electronic parameters by four orders of magnitude, thus bringing optical neural networks into the modern deep learning era.

### Results

### Large-Kernel Spatially-Varying Parameterization

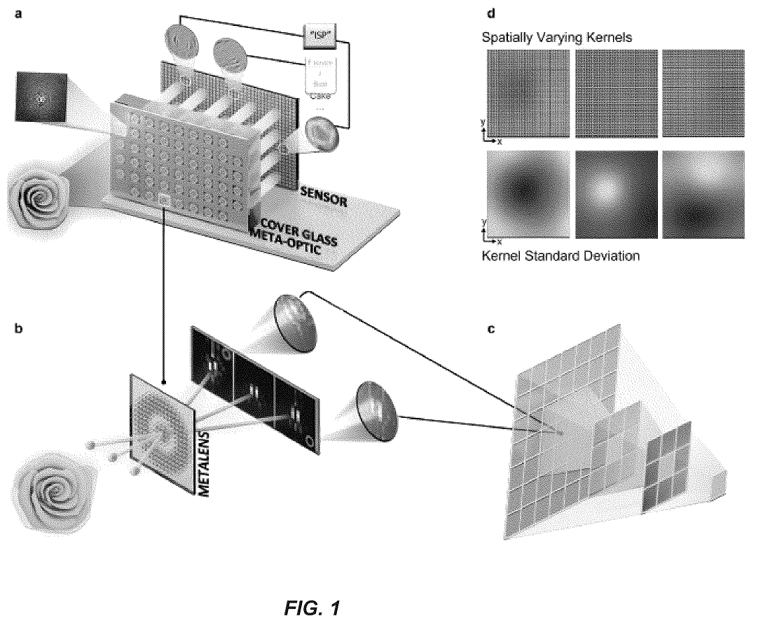

FIG. 1 illustrates spatially varying nanophotonic neural networks according to one embodiment of the present disclosure. (a) of FIG. 1 provides an illustration of the proposed opto-electronic network, which comprises a nanophotonic array front-end that optically encodes the scene into multichannel image features, and a lightweight electronic back-end that performs the final prediction, in a programmable manner, for image classification or semantic segmentation; in (b) of FIG. 1, each metalens is designed for specific large and angularly varying point spread functions that comprise the feature kernels of the early net-work layers which vary over the sensor. These kernels are learned electronically using a spatially varying re-parameterization. Referring to (c) of FIG. 1, disclosed embodiments learn large kernels by factorizing them into a cascade of smaller ones. The representative spatially varying kernels over space (first row) and the corresponding kernel standard deviation at each spatial location are illustrated in (d) of FIG. 1.

The working principle and optoelectronic implementation of the proposed spatially varying nanophotonic neural network (SVN³) are illustrated (see (a) of FIG. 1). The SVN³ is an optoelectronic neuromorphic computer that comprises a metalens array nanophotonic front-end and a lightweight electronic back-end (embedded in a low-cost micro-controller unit) for image classification or semantic segmentation. The metalens array front-end consists of 50 metalens elements that are made of 350 nm pitch nano-antennas and are optimized for incoherent light in a band around 525 nm. The wavefront modulation induced by each metalens can be represented by the optical convolution of the incident field and the point spread functions (PSF) of the individual device. Therefore, the nanophotonic front-end performs parallel multichannel convolutions, at the speed of light, without any power consumption.

Unlike existing ONNs^{35-38, 44} that engineer the optical response to mimic a convolutional layer that consists of spatially-invariant small-sized kernels, the SVN³ employs large-sized angularly varying PSFs (see (b) of FIG. 1) as the convolution kernels to construct a large-kernel spatially-varying (LKSV) convolutional layer. Such an LKSV convolutional layer is seldom used in deep neural networks due to immense computation costs and challenges in training. Nevertheless, disclosed demonstrate that with low-dimensional reparametrization techniques, namely large kernel factorization, and low-rank spatially-varying re-parameterization, this computing layer can be effectively learned in silicon, circumventing spurious local minima that can arise from naïve over-parametrization.

Disclosed embodiments reparameterize a large (15×15) convolutional kernel into a stack of (seven) small 3×3 kernels, which are convolved sequentially to the large kernel (see (d) of FIG. 1). The spatially-varying structure is reparameterized through a spatially-variant weighted linear combination of a (large) kernel basis, which resembles the low-rank approximation of a general spatially-varying kernel. As such, disclosed embodiments construct a 3-layer convolutional neural network (CNN) composed of an LKSV convolutional stem, a depth-wise separable convolutional layer, and a fully-connected classification head, for CIFAR-10 image classification. This CNN is trained in silicon by minimizing the standard cross-entropy loss with tailored regularizations (an isotropic total variation regularization and a specialized spectrum regularization) on the spatially-varying kernels. Validated by the spatial combining weights and the Fourier spectrum profiles of learned kernels, these regularizations enforce smooth transitions of spatially-varying kernels and penalize high-pass and ill-conditioned kernels, which are challenging to implement in an optical system. After in-silicon training, the disclosed LKSV design performs favorably compared to the conventional small-kernel spatially-invariant (SKSI) counterpart by a sizable margin, lifting from the LeNet-level accuracy (65.45%) to the AlexNet-level accuracy (73.80%) (Table 1).

TABLE 1

| | | MAC | | TIME | | | # OF PARAMS | |
|---|---|---|---|---|---|---|---|---|
| MODEL | ACC | OPTICAL ↑ | ELECTRONIC ↓ | OPTICAL ↑ | | ELECTRONIC ↓ | OPTICAL ↑ | ELECTRONIC ↓ |
| AlexNet | 72.64% | — | 174.93M | — | | 70.58 us | — | 57.03M |
| | | — | 100% | — | | 100% | — | 100% |
| SKSI | 65.45% | 281.60K | 216.50K | 0.41 | us | 2.64 us | 0.27K | 2.18K |
| | | 56.53% | 43.47% | 13.56% | | 86.44% | 11.18% | 88.82% |
| LKSI | 71.64% | 5.81M | 216.50K | 3.54 | us | 2.64 us | 5.67K | 2.18K |
| | | 96.41% | 3.59% | 57.25% | | 42.75% | 71.74% | 28.26% |
| SKSV | 71.14% | 1.43M | 216.50K | 27.72 | us | 2.64 us | 6.52K | 2.18K |
| | | 86.88% | 13.12% | 91.30% | | 8.70% | 74.47% | 25.53% |
| LKSV | 73.80% | 34.61M | 216.50K | 302.66 | us | 2.64 us | 38.92K | 2.18K |

| | | | | | |
|---|---|---|---|---|---|
| 99.38% | 0.62% | 99.14% | 0.86% | 94.57% | 5.43% |

Table 1: Ablation experiments for the proposed design variant (LKSV): Disclosed embodiments report the number of multiply-accumulate (MAC) operations, the inference runtime (TIME) and the number of parameters (# of PARAMS) for the optical and electronic parts of different models. The runtime is measured on an NVIDIA GTX 1080Ti GPU; note that the true optical runtime is only determined by the pathlength and ≈3 ps in the disclosed implementation. Disclosed embodiments report here runtime numbers of the optical model component when implemented electronically for reference, i.e., higher is better. The labels SK/LK refer to small and large kernel respectively; SI/SV indicate spatially invariant and spatially varying respectively. ACC denotes the blind testing accuracy on the CIFAR-10 dataset. The result of AlexNet is also listed as a reference.

The high computational cost of LKSV convolution in silicon can be entirely eliminated by designing a passive optical system with metalenses whose PSFs are inverse designed to mimic the designated target kernels. While the target kernels may contain both positive and negative values, optical PSFs contain only non-negative values. Thus, to generate each target kernel disclosed embodiments employ a pair of metalenses and disclosed embodiments take the subtraction of their image features post-convolution to achieve positive and negative values.

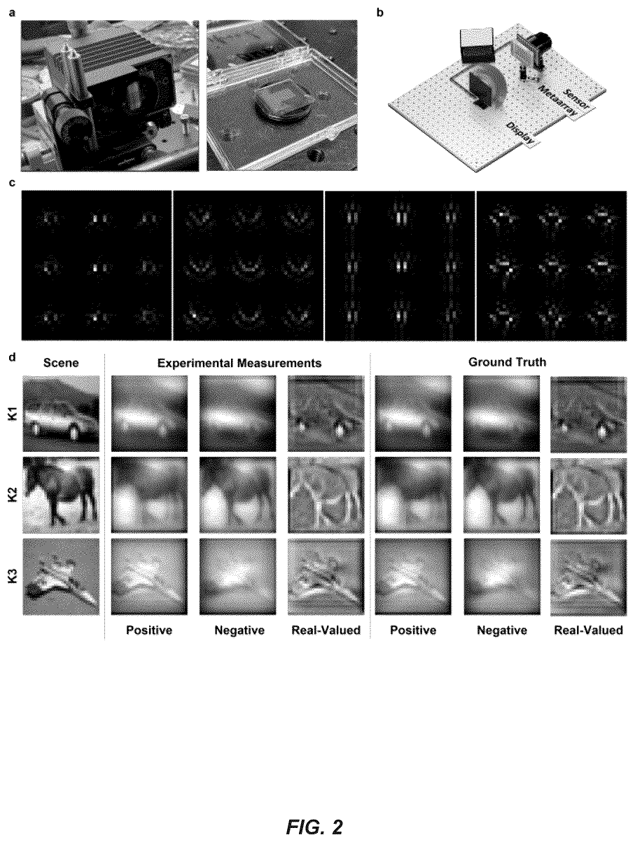

FIG. 2 illustrates an experimental validation of SVN³ according to one embodiment of the present disclosure. (a) of FIG. 2 illustrates a close-up of the metalens array camera and a metalens array device before mounting; (b) of FIG. 2 illustrates an experimental setup, consisting of an OLED display placed at the designed object distance, and a large-area CMOS sensor is placed at the focal plane of the metalens array. Both are synchronized for data capture; (c) of FIG. 2 illustrates a spatially-varying PSF visualization on a 3×3 sampling grid of incident angles. Disclosed embodiments show four representative kernels; (d) of FIG. 2 illustrate side-by-side comparisons of the experimental measurements and the corresponding ground truth feature channels. “Real-valued” denotes the target feature channel, that is the negative image feature subtracted from positive image features post-convolution.

To optically realize a 25-channel LKSV convolutional layer, disclosed embodiments instantiate an on-chip metalens array that consists of 50 metalenses with the device layout shown (see (a) in FIG. 1 and (a) in FIG. 2). To engineer spatially-varying PSFs, disclosed embodiments simulate the optical system and use a differentiable spatially-varying inverse design framework to compute the phase profiles of the metalenses via stochastic gradient-based optimization. The angularly varying PSFs are optimized by minimizing the mean square error loss with respect to the target electronic kernels and employing an energy regularization to maximize the localized energy in the region of interest on the sensor plane. By employing energy regularization, disclosed embodiments improve the light efficiency of the designed metalenses from 39.37% to 93.88% without impacting the PSF accuracy and make the ONNs more robust to unwanted scattering light and other noise in real-world measurement.

The proposed optical simulation framework allows for pre-fabrication evaluation of the design quality through metrics such as PSF approximation normalized root mean square error (NRMSE), image feature discrepancy in NRMSE, and light efficiency. The PSF error map, as shown in Figure S5a, indicates that the simulated spatially varying PSFs at each of the 32×32 sampling incident angles closely resemble those of the target electronic kernels with 10.49% mean NRMSE. The bar plots in show the image feature discrepancies (NRMSE) for the 50 metalenses. The feature discrepancies in NRMSE (43.80% at average) are higher than the PSF errors owing to inaccuracies that can arise from representing discrete convolution kernels using spatially continuous light fields, as well as the error amplification caused by ill-conditioned target kernels. Note that these target kernels were regularized by the specialized spectrum penalty at the training phase, which reduced their condition numbers and thus reduced the average image feature discrepancy (NRMSE) from 66.46% to 43.80%. Although enforcing stronger condition regularization can further close the gap between simulated device performance and real-world device performance, this would severely degrade the model recognition accuracy, as less regularized kernels could extract more discriminative features for classification.

### Experimental Validation

The inverse-design-optimized metalens array was fabricated in a single chip in a silicon nitride on quartz film. Disclosed embodiments used a nanopatterning approach using electron beam lithography to define the outline of the design in a resist, deposited a hard mask, and subsequently transferred the pattern into the underlying silicon nitride using reactive ion etching. To exclude transmission of light through non-patterned sections disclosed embodiments further deposited a metal aperture around the ONN metalens kernels. The chip close-up and the microscope image of one of the metalenses are shown in (a) of FIG. 2, where the fabricated nanophotonic structure is visually consistent with the designed phase profile. The PSFs (over 3×3 varied sampling incident angles) of three randomly selected kernels are illustrated in (c) of FIG. 2, which illustrates the spatially-varying features of the designed optical kernels. To experimentally realize the optical system and measure the image features of the metalenses, disclosed embodiments built the setup as shown in (b) of FIG. 2. The green channel of a smartphone OLED display, which is placed at the designed object distance, is used as the in-coherent light source, and a large-area CMOS sensor is placed at the focal plane of the metalens array device. When the dataset images are displayed on the smartphone, the sensor captures the corresponding image features of all the metalens elements in one shot. The captured positive, negative, and real-valued features thru subtraction closely resemble the electronic ground truth from both qualitative and quantitative comparisons, which verifies the effectiveness of the implemented inverse design framework (see (d) of FIG. 2).

To extensively assess the performance of the disclosed opto-electronic neural network SVN³, disclosed embodiments captured the entire grayscale CIFAR-10 dataset, including 50,000 training images and 10,000 testing images, with the setup described above and shown in (b) of FIG. 2. The image features in each frame are equally spaced in a regular 6×9 array with the four corners being traditional hyperbolic metalenses used for device alignment. After cropping the image features of all the metalenses and computing the real-valued target features through paired subtraction, the resulting multichannel optical features are fed into the pretrained lightweight electronic backend to obtain the final predictions. Disclosed embodiments finetune the electronic backend using the cross-entropy loss on the experimentally captured CIFAR-10 training dataset. The finetuning procedure is identical to the prior in-silicon training of the target electronic neural network, except no extra regularization losses are applied.

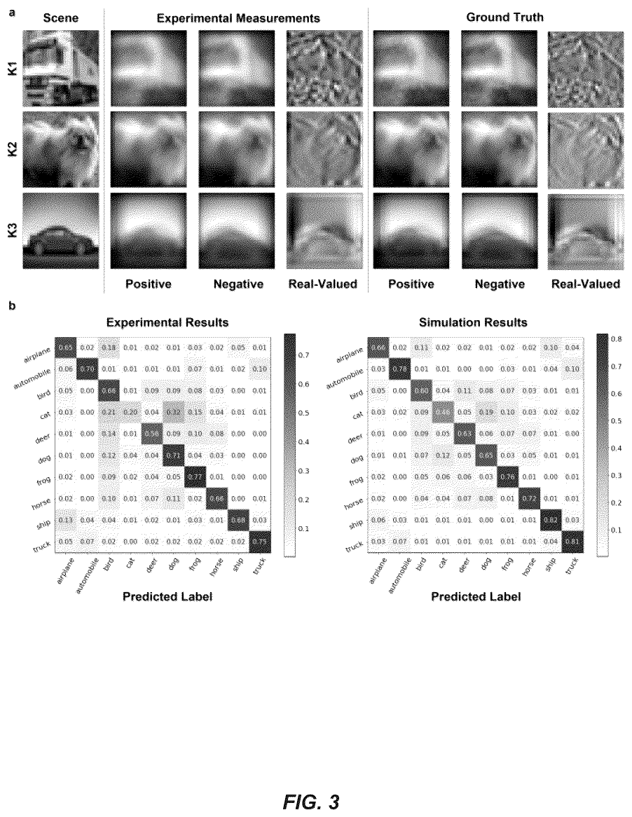

FIG. 3 illustrates experimental measurements of a fabricated chip of a design for CIFAR-10 image classification according to one embodiment of the present disclosure. (a) of FIG. 3 illustrates a qualitative assessment of the experimental measurements compared with the ground truth feature channels. “Real-valued” again denotes here the target feature channels via subtraction of the negative from the positive image features post-convolution. (b) of FIG. 3 illustrates the confusion matrices of the experimental and simulation results on CIFAR-10 testing dataset.

The disclosed SVN³ reaches to 73.12% on the projected CIFAR-10 testing dataset, which is comparable to 73.80% of the corresponding electronic model. Similar observations are also drawn in the confusion matrices in (b) of FIG. 3, which reveals the similar recognition behavior of the SVN³ in real experiment and simulation. Disclosed embodiments emphasize that almost all computation (>99% of MACs) of SVN³ is executed on the optical side with zero energy consumption (Table 1). This AlexNet-level classification accuracy is thus achieved with an ultra-low power device.

Versatile Computational Camera The disclosed approach is generic which disclosed embodiments validate by instantiating SVN³ for other datasets and tasks. Next, disclosed embodiments describe such an instance for ImageNet classification with 1000 object categories. ImageNet is the first large-scale image classification dataset with 1.28 million labeled training data, serving as a major driving factor to advance modern AI. According to disclosed embodiments, it is believed that no existing ONN has reported results on ImageNet classification so far. Using physical parameters, disclosed embodiments inverse design and fabricate an on-chip metasurface array to optically encode features for 64×64 low-resolution ImageNet classification. Notice with a larger form factor, the disclosed system facilitates scaling to support original 224×224 high-resolution recognition. As for the CIFAR-10 experiment, the entire training and validation datasets of ImageNet are encoded into optical features by the imaging system for finetuning and evaluation. The experimentally captured features consistently align with their electronic ground truth (see (b) of FIG. 3), validating the scalability and effectiveness of SVN³ to process large-sized image features. After finetuning the electronic backend on the projected ImageNet training set, the SVN³ achieves 51.28% top-5 classification accuracy in ImageNet validation set, outperforming AlexNet by 3.6%. Note that the SVN³ for 64×64 ImageNet classification has 1.67M digital multiply-accumulate operations (MACs), which is only 0.9% of AlexNet (180.26M).

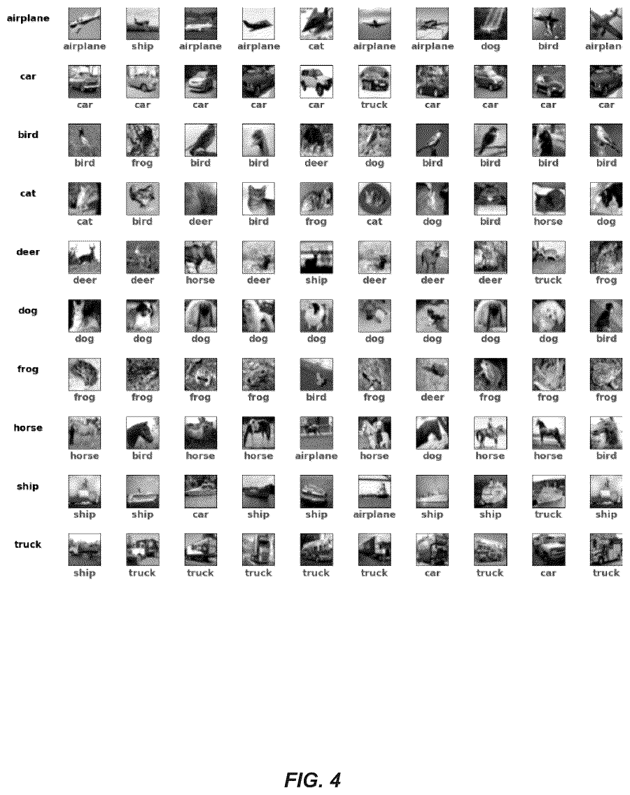

FIG. 4 illustrates experimental classification results on random samples from a CIFAR-10 test set according to one embodiment of the present disclosure. Green and red colored labels under the images denote the correct and incorrect predictions, respectively.

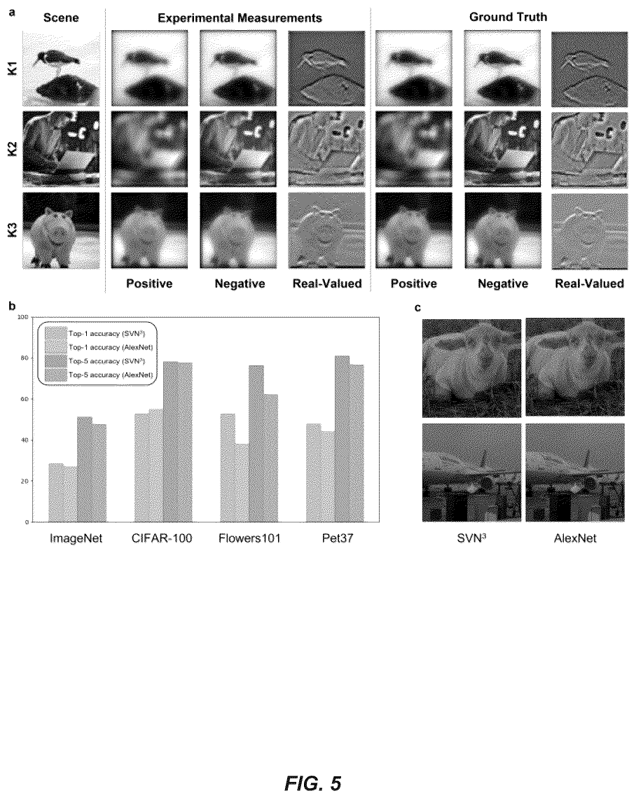

FIG. 5 illustrates validation of SVN³ as a versatile computational camera according to one embodiment of the present disclosure. (a) of FIG. 5 provides feature maps of SVN³ on ImageNet dataset. (b) of FIG. 5 illustrates recognition performance of the ImageNet-designed SVN³ instance, on ImageNet and other downstream datasets (CIFAR-100, Flowers102 and Pet37) using the universal optical encoder, and the transfer-learned electronic decoder. These findings validate that the proposed camera, with a fixed optical encoder, can generalize to diverse tasks by adapting the electronic backend.

Although the optical frontend (encoder) in SVN³ is not programmable after being fabricated, disclosed embodiments demonstrate by designing the optical kernels in the large-scale dataset (ImageNet), SVN³ can serve as a versatile computational camera with a universal optical encoder. By adjusting the electronic backend (decoder) using transfer learning, SVN³ is capable of performing diverse vision tasks beyond the initially designed task. Using the same physical setup for ImageNet classification, disclosed embodiments conduct image recognition experiments on the CIFAR-100, Flowers102, and Pet37 datasets. For all of these datasets, disclosed embodiments achieve comparable or better performance than AlexNet (see (b) of FIG. 5), consistently validating the flexibility of the disclosed hybrid opto-electronic system without adapting the optical frontend. This capability also manifests in other computer vision tasks, e.g., semantic segmentation in PASCAL VOC dataset, where the disclosed hybrid network is competitive to the AlexNet-based segmentation network. The disclosed SVN³ leads to pixel accuracy of 65.73% compared with 66.34% of AlexNet-based segmentation on the PASCAL VOC testing set.

### DISCUSSION

In this work, disclosed embodiments investigate a novel nanophotonic neural network, that transcends the limitations of existing optical neural networks, propelling them to performance parity with the first modern digital neural network, AlexNet. By introducing a large-kernel spatially-varying convolutional neural network, learned via low-dimensional re-parameterization techniques, and physically realizing it via a meta-optical system, disclosed embodiments have achieved an image classification accuracy of (top-1) 73.12% on CIFAR-10 and (top-5) 51.28% on ImageNet. The proposed method shifts almost all computation from electronic processors into the optical domain. Specifically, disclosed embodiments reduce the number of multiply-add floating point operations by 99.38%. The proposed regularization and parameterization reduce the discrepancy between electronic and optically implemented convolutions, and as a result, disclosed embodiments achieve an optical implementation NRMSE of 43.80%. In the future, further reducing this discrepancy and extending the design framework to the broadband visible light regime could enable ultra-fast computer vision for a wide gamut of applications. According to disclosed embodiments, it is believed that the proposed optical neural network is a first step to bridging the gap between photonic and electronic artificial intelligence, and disclosed embodiments anticipate that these devices could enable ultra-low latency computing at the edge.

### Methods

Design and Optimization Disclosed embodiments used PyTorch to design and evaluate the disclosed spatially-varying nano-photonic neural network.

Sample Fabrication Disclosed embodiments fabricated the meta-optic on top of a 500 μm thick double-side polished fused silica wafer. First, a 800 nm film of silicon nitride was deposited via plasma-enhanced chemical vapor deposition (PECVD) in a SPTS DeltaX PECVD using Silane and Ammonia as the precursor for a growth at 350° C. After growth, the wafer is diced in pieces of 2×2 cm and cleaned in a sonicating bath of Acetone, followed by a rinse in Iso-Propyl Alcohol (IPA). Then the sample was shortly cleaned in a O2 plasma using a barrel etcher at 100 W for ˜15 s. After the cleaning step, disclosed embodiments spin-coated the sample with ZEP 520A resist (˜400 nm), followed by a layer of a discharging polymer (DisCharge H2O). The arrays of kernels were then written on single chips for the spatially varying and spatially invariant designs via electron beam lithography (EBL) using a JEOL-JBX6300FS with acceleration voltage of 100 kV and 8 nA beam current. After EBL, the sample was rinsed in IPA and developed in amyl acetate for 2 min and rinsed in IPA. To define a hard mask, disclosed embodiments evaporated 65 nm of alumina using a lab-built e-beam evaporator and a Al2O3 evaporation source. The resist was then lift-off overnight in NMP at 110° C. and the sample was further cleaned in a brief O2 plasma etch to remove remaining organic residues. Disclosed embodiments then used inductively-coupled reactive ion etching (Oxford Instruments, PlasmaLab100) with an etch chemistry based on Fluorine to transfer the metasurface layout from the hard mask into the silicon nitride film to a thickness of ˜750 nm, whereas the remaining 50 nm of PECVD ensures higher stability of the etched device layer. After fabrication of the device layer, disclosed embodiments deposited a metal aperture layer surrounding the metasurfaces to exclude any stray light. These apertures were created through optical direct write lithography (Heidelberg-DWL66) and subsequent deposition of a 150 nm thick metal film (Cr).

Experimental Setup Disclosed embodiments built two setups: The first one is used to experimentally measured the PSFs of the metalens array samples. In this setup, a 520 nm pigtailed fiber laser is used as the light source and a CMOS sensor is used as the detector. A microscopic objective together with a relay lens is used to magnify the PSF measurement on the detector plane. The second setup is used to realize the designed optical system and to measure the image features, as shown in (a) and (b) of FIG. 2. In this setup, the green channel of a smartphone OLED display that is placed at the designed object distance, is used as the incoherent light source, and a large-area CMOS sensor is placed at the focal plane of the metalens array device. The smartphone and the sensor are controlled by a computer and synchronized such that when the dataset images are displayed on the smartphone sequentially, the sensor captures the corresponding image features of all the metalens elements in a single shot.

Data Availability The source images used throughout this work are publicly available. The raw capture data will be available.

Code Availability The code used to design and evaluate the spatially-varying nanophotonic neural network will be publicly available on Github.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. Moore, G. E. Cramming more components onto integrated circuits. Proceedings of the IEEE 86, 82-85 (1998).
2. Waldrop, M. M. The chips are down for moore's law. Nature News 530, 144 (2016).
3. LeCun, Y., Bengio, Y. & Hinton, G. Deep learning. Nature 521, 436-444 (2015).
4. Sevilla, J. et al. Compute trends across three eras of machine learning. arXiv preprint arXiv: 2202.05924 (2022).
5. Horowitz, M. 1.1 computing's energy problem (and what we can do about it). In 2014 IEEE International Solid-State Circuits Conference Digest of Technical Papers (ISSCC), 10-14 (IEEE, 2014).
6. Solli, D. R. & Jalali, B. Analog optical computing. Nature Photonics 9, 704-706 (2015).
7. Caulfield, H. J. & Dolev, S. Why future supercomputing requires optics. Nature Photonics 4, 261-263 (2010).
8. Miller, D. A. Attojoule optoelectronics for low-energy information processing and communications. Journal of Lightwave Technology 35, 346-396 (2017).
9. Miller, D. A. Are optical transistors the logical next step? Nature Photonics 4, 3-5 (2010).
10. Tucker, R. S. The role of optics in computing. Nature Photonics 4, 405-405 (2010).
11. Wetzstein, G. et al. Inference in artificial intelligence with deep optics and photonics. Nature 588, 39-47 (2020).
12. Shastri, B. J. et al. Photonics for artificial intelligence and neuromorphic computing. Nature Photonics 15, 102-114 (2021).
13. Wu, J. et al. Analog optical computing for artificial intelligence. Engineering (2021).
14. Liu, W. et al. A fully reconfigurable photonic integrated signal processor. Nature Photonics 10, 190-195 (2016).
15. Kwon, H., Sounas, D., Cordaro, A., Polman, A. & Al′u, A. Nonlocal metasurfaces for optical signal processing. Physical Review Letters 121, 173004 (2018).
16. Silva, A. et al. Performing mathematical operations with metamaterials. Science 343, 160-163 (2014).
17. Zhu, T. et al. Plasmonic computing of spatial differentiation. Nature Communications 8, 1-6 (2017).
18. Ferrera, M. et al. On-chip cmos-compatible all-optical integrator. Nature Communications 1, 1-5 (2010).
19. Xu, X.-Y. et al. A scalable photonic computer solving the subset sum problem. Science Advances 6, eaay5853 (2020).
20. Mohammadi Estakhri, N., Edwards, B. & Engheta, N. Inverse-designed metastructures that solve equations. Science 363, 1333-1338 (2019).
21. Feldmann, J., Youngblood, N., Wright, C. D., Bhaskaran, H. & Pernice, W. H. All-optical spiking neurosynaptic networks with self-learning capabilities. Nature 569, 208-214 (2019).
22. Xu, X. et al. 11 tops photonic convolutional accelerator for optical neural networks. Nature 589, 44-51 (2021).
23. Shen, Y. et al. Deep learning with coherent nanophotonic circuits. Nature photonics 11, 441-446 (2017).
24. Feldmann, J. et al. Parallel convolutional processing using an integrated photonic tensor core. Nature 589, 52-58 (2021).
25. Ashtiani, F., Geers, A. J. & Aflatouni, F. An on-chip photonic deep neural network for image classification. Nature 1-6 (2022).

26 Tait, A. N. et al. Neuromorphic photonic networks using silicon photonic weight banks. Scientific Reports 7, 1-10 (2017).
27. Te ̆gin, U., Yιdιrιm, M., O ̆guz, I., Moser, C. & Psaltis, D. Scalable optical learning operator. Nature Computational Science 1, 542-549 (2021).
28. Lin, X. et al. All-optical machine learning using diffractive deep neural networks. Science 361, 1004-1008 (2018).
29. Mengu, D., Luo, Y., Rivenson, Y. & Ozcan, A. Analysis of diffractive optical neural networks and their integration with electronic neural networks. IEEE Journal of Selected Topics in Quantum Electronics 26, 1-14 (2019).
30. Yan, T. et al. Fourier-space diffractive deep neural network. Physical Review Letters 123, 023901 (2019).
31. Rahman, M. S. S., Li, J., Mengu, D., Rivenson, Y. & Ozcan, A. Ensemble learning of diffractive optical networks. Light: Science & Applications 10, 1-13 (2021).
32. Luo, X. et al. Metasurface-enabled on-chip multiplexed diffractive neural networks in the visible. Light: Science & Applications 11, 1-11 (2022).
33. Hamerly, R., Bernstein, L., Sludds, A., Solja ̌ci'c, M. & Englund, D. Large-scale optical neural networks based on photoelectric multiplication. Physical Review X 9, 021032 (2019).
34. Zhou, T. et al. Large-scale neuromorphic optoelectronic computing with a reconfigurable diffractive processing unit. Nature Photonics 15, 367-373 (2021).
35. Shi, W. et al. Loen: Lensless opto-electronic neural network empowered machine vision. Light: Science & Applications 11, 1-12 (2022).
36. Zheng, H. et al. Meta-optic accelerators for object classifiers. Science Advances 8, cabo6410 (2022).
37. Chang, J., Sitzmann, V., Dun, X., Heidrich, W. & Wetzstein, G. Hybrid optical-electronic convolutional neural networks with optimized diffractive optics for image classification. Scientific Reports 8, 1-10 (2018).
38. Colburn, S., Chu, Y., Shilzerman, E. & Majumdar, A. Optical frontend for a convolutional neural network. Applied Optics 58, 3179-3186 (2019).
39. LeCun, Y. et al. Handwritten digit recognition with a back-propagation network. Advances in Neural Information Processing Systems 2 (1989).
40. Krizhevsky, A., Sutskever, I. & Hinton, G. E. Imagenet classification with deep convolutional neural networks. Advances in Neural Information Processing Systems 25 (2012).
41. Khorasaninejad, M. & Capasso, F. Metalenses: Versatile multifunctional photonic components. Science 358, caam8100 (2017).
42. Dorrah, A. H. & Capasso, F. Tunable structured light with flat optics. Science 376, cabi6860 (2022).
43. Krizhevsky, A., Hinton, G. et al. Learning multiple layers of features from tiny images (2009).
44. Fu, W. et al. Ultracompact meta-imagers for arbitrary all-optical convolution. Light: Science & Applications 11, 62 (2022).

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. A nanophotonic neural network comprising:
a large-kernel spatially-varying convolutional neural network,
wherein the large-kernel spatially-varying convolutional neural network is taught via a low-dimensional re-parameterization technique,
wherein the large-kernel spatially-varying convolutional neural network comprises a flat meta-optical system that encompasses an array of nanophotonic structures designed to induce angle-dependent responses,
wherein the large-kernel spatially-varying convolutional neural network comprises an electronic backend with approximately 2K parameters configured to reach a 73.80% blind test classification accuracy on CIFAR-10 dataset.

2. The nanophotonic neural network of claim 1, wherein the nanophotonic neural network comprises an optoelectronic neuromorphic computer.

3. The nanophotonic neural network of claim 2, wherein the optoelectronic neuromorphic computer comprises a metalens array nanophotonic front-end and an electronic back-end embedded in a micro-controller unit.

4. The nanophotonic neural network of claim 3, wherein the metalens array nanophotonic front-end consists of 50 metalens elements that are made of 350 nm pitch nano-antennas and are optimized for incoherent light in a band around 525 nm.

5. The nanophotonic neural network of claim 1, wherein a larger convolutional kernel is reparameterized into a stack of smaller kernels which are convolved sequentially to the larger convolutional kernel.

6. The nanophotonic neural network of claim 5, wherein the large convolutional kernel comprises a 15×15 convolutional kernel and the smaller kernels comprises a stack of seven smaller 3×3 kernels to thereby produce a 3-layer convolutional neural network.

7. The nanophotonic neural network of claim 6, wherein the convolutional neural network comprises a large-kernel spatially-varying (LKSV) convolutional layer convolutional stem, a depth-wise separable convolutional layer, and a fully-connected classification head, for CIFAR-10 image classification.

8. The nanophotonic neural network of claim 6, wherein the convolutional neural network is trained in silicon by minimizing a standard cross-entropy loss with tailored regularizations on spatially-varying kernels.

9. The nanophotonic neural network of claim 8, wherein the tailored regularizations comprise an isotropic total variation regularization and a specialized spectrum regularization.

10. The nanophotonic neural network of claim 2, wherein the metalens array is fabricated in a single ship in a silicon nitride on quartz film.

11. A method of designing nanophotonic neural network comprising:
employing an optoelectronic neuromorphic computer having a metalens array comprising a plurality of metalenses;
teaching a large-kernel spatially-varying convolutional neural network of the nanophotonic neural network by applying a low-dimensional re-parameterization technique, wherein the large-kernel spatially-varying convolutional neural network comprises a flat meta-optical system that encompasses an array of nanophotonic structures designed to induce angle-dependent responses;
re-parameterizing a larger convolutional kernel into a stack of smaller kernels which are convolved sequentially to the larger convolutional kernel; and
simulating an optical system to compute phases profiles of the plurality of metalenses.

12. The method of claim 11, wherein the large convolutional kernel comprises a 15×15 convolutional kernel and the smaller kernels comprises a stack of seven smaller 3×3 kernels to thereby produce a 3-layer convolutional neural network.

13. The method of claim 12, comprising:
training the convolutional neural network in silicon by minimizing a standard cross-entropy loss with tailored regularizations on spatially-varying kernels.

14. The method of claim 13, wherein the tailored regularizations comprise an isotropic total variation regularization and a specialized spectrum regularization.

15. The method of claim 13, wherein the tailored regularizations comprise an isotropic total variation regularization and a specialized spectrum regularization.

16. The method of claim 13, wherein the metalens array is fabricated in a single ship in a silicon nitride on quartz film.

17. The method of claim 12, wherein the, wherein the convolutional neural network comprises a large-kernel spatially-varying (LKSV) convolutional layer convolutional stem, a depth-wise separable convolutional layer, and a fully-connected classification head, for CIFAR-10 image classification.

18. The method of claim 11, wherein simulating an optical system to compute phases profiles of the plurality of metalenses is performed via stochastic gradient-based optimization.

19. The method of claim 11, comprising:
optimizing an angular varying point spread functions (PSF).

20. The method of claim 19, wherein the angular varying point spread functions (PSF) are optimized by minimizing a mean square error loss with respect to target electronic kernels and employing an energy regularization to maximize a localized energy in a region of interest on a sensor plane.
